(19) United States
(12) Patent Application Publication
(10) Pub. No.: US 2025/0278675 A1
(43) Pub. Date: Sep. 4, 2025

(54) MACHING LEARNING SYSTEMS

(71) Applicant: Beforepay IP Pty Ltd, Sydney (AU)

(72) Inventors: James Spencer TWISS, Sydney (AU); Geoffrey Cheng Kang CHANG, Sydney (AU); Jianfeng ZHANG, Sydney (AU)

(21) Appl. No.: 19/065,559

(22) Filed: Feb. 27, 2025

(30) Foreign Application Priority Data
Feb. 29, 2024 (AU) 2024201363

(51) Int. Cl. G06N 20/20; G06F 16/28

(52) U.S. Cl. CPC G06N 20/20; G06F 16/285

(57) ABSTRACT

Systems and methods for training a machine learning model to assess risk as disclosed. The machine learning model includes a plurality of machine learning sub-models and an ensemble model. The method includes: receiving a plurality of user data records, each user data record comprising data collected for an individual user from multiple data sources; creating the plurality of machine learning sub-models based on the plurality of user data records; assigning at least a subset of the plurality of user data records to each of the plurality of machine learning sub-models; training each machine learning sub-model using the assigned subset of the plurality of user data records, each sub-model trained to accurately determine a risk score based on a given user data record; providing the risk scores generated by each of the plurality of machine learning sub-models to an ensemble machine learning model, the ensemble machine learning model being trained to combine the risk scores from the sub-models to obtain a combined risk score; using the trained machine learning model to determine a risk score for an individual user data record; and reusing the determined risk score for the individual user record to retrain the machine learning model.

### TECHNICAL FIELD

The present application relates generally to machine learning models, and more particularly to training and using new combinations of machine learning models for risk assessment:

### BACKGROUND

Credit risks can arise when credit is extended to account holders that are likely to default. Financial institutions are particularly concerned with offering credit based on the perceived risk of default associated with a potential credit. Financial institutions may implement risk assessment systems to assess risk, but those systems have traditionally only been as effective as the expert-written rules guiding the systems.

Models may be used in some scenarios to predict a likely outcome. For example, models may be built and used in assessing credit risk. However, such models are often sub-optimal at best, as there may be a gap between a loss function that machine learning uses and a metric used to evaluate the accuracy and/or precision of the model. Inaccurate models may result in inefficient characterization of credit risk of customers (i.e., more defaults can occur than expected). Thus, inaccurate models could result in greater losses for financial institutions.

Accordingly, there is a need for improved risk assessment systems that can predict risk, such as credit default risk, more accurately than previously known systems.

### SUMMARY

According to a first aspect of the present disclosure, there is provided a method for training a machine learning model to assess risk, the machine learning model comprising a plurality of machine learning sub-models and an ensemble model, the method comprising: receiving a plurality of user data records, each user data record comprising data collected for an individual user from multiple data sources; creating the plurality of machine learning sub-models based on the plurality of user data records; assigning at least a subset of the plurality of user data records to each of the plurality of machine learning sub-models, training each machine learning sub-model using the assigned subset of the plurality of user data records, each sub-model trained to accurately determine a risk score based on a given user data record; providing the risk scores generated by each of the plurality of machine learning sub-models to an ensemble machine learning model, the ensemble machine learning model being trained to combine the risk scores from the sub-models to obtain a combined risk score; using the trained machine learning model to determine a risk score for an individual user data record; and reusing the determined risk score for the individual user record to retrain the machine learning model.

According to a second aspect of the present disclosure there is provided a computer processing system including: one or more processing units; and one or more non-transitory computer-readable storage media storing instructions, which when executed by the one or more processing units, cause the one or more processing units to perform the method of the first aspect.

According to a third aspect of the present disclosure there is provided one or more non-transitory storage media storing instructions executable by one or more processing units to cause the one or more processing units to perform the method of the first aspect.

### BRIEF DESCRIPTION OF THE DRAWINGS

In the drawings:

FIG. 1 is a block diagram depicting a networked environment in which various features of the present disclosure may be implemented.

FIG. 2 is a block diagram of a risk assessment platform according to one embodiment of the present disclosure.

FIG. 3 is a block diagram of a computer processing system configurable to perform various features of the present disclosure.

FIG. 4 is a flowchart illustrating an example method for iteratively training a machine learning model to assess risk.

FIG. 5 is a flowchart illustrating an example method of processing source data according to some embodiments of the present disclosure.

FIG. 6 is a flowchart depicting an example method for analyzing processed source data according to some embodiments of the present disclosure.

FIG. 7 is a flowchart depicting an example method for creating sub-models based on clusters in the processed source data according to some embodiments of the present disclosure.

FIG. 8 is a flowchart depicting an example method for configuring and training a sub-model according to some embodiments of the present disclosure.

FIG. 9 is a flowchart depicting an example method for calculating a risk score for a request according to some embodiments of the present disclosure.

While the description is amenable to various modifications and alternative forms, specific embodiments are shown by way of example in the drawings and are described in detail. It should be understood, however, that the drawings and detailed description are not intended to limit the invention to the particular form disclosed. The intention is to cover all modifications, equivalents, and alternatives falling within the scope of the present invention as defined by the appended claims.

### DETAILED DESCRIPTION

In the following description numerous specific details are set forth in order to provide a thorough understanding of the present invention. It will be apparent, however, that the present invention may be practiced without these specific details. In some instances, well-known structures and devices are shown in block diagram form in order to avoid unnecessary obscuring.

Generally speaking, aspects of the present disclosure are related to an intelligent risk assessment system and to the training of such a system to generate accurate risk scores. In particular, the techniques disclosed herein are described in the context of a risk assessment system that is trained to determine the probability of risk associated with providing a service to a user.

Conventional risk assessment models are generally inaccurate and therefore introduce an element of risk and uncertainty when used. Further, the user data utilized in conventional risk assessment models may be difficult to analyze or lead to incorrect results. In one example, this may be because financial trends that appear within a smaller subset of users may be overlooked by trends followed by larger subsets of users. One flaw in previously known risk assessments is that the risk factors of smaller subsets of a heterogeneous population may be outweighed or influenced by the risk factors of a larger subset of that same population.

The presently disclosed systems and method address these issues by identifying and isolating different subsets of users and identifying trends within each subset of users. By doing so, smaller subsets of users may still be represented during training of a machine learning (ML) model, allowing the ML model to develop more personalized and accurate risk scores for any type of user.

In particular, aspects of the present disclosure provide novel methods for developing and training ML models to analyze user data to obtain risk scores. To do so, the systems and methods described herein segregate users into different clusters based on arbitrary filters applied to user data. For example, the systems and methods may generate different clusters of users by filtering user ‘phone type’ and ‘bank’ data. In another example, clusters of users may be generated by filtering user data based on ‘spending location’, The systems and methods disclosed herein generate ML sub-models for each of the clusters and then train those sub-models to evaluate the features which best define each sub-model. For example in the cluster formed based on ‘phone type’ and ‘bank’, the feature of ‘amount of spending over the past 30 days’ may be identified as a feature that best defines the sub-model. The outputs of the trained sub-models are then combined into an ensemble model which outputs a risk score given specific user data.

By separating the user data into different clusters based on arbitrary filters, the sub-models are able to identify trends within specific subsets of users more accurately. In this way, the presently disclosed risk assessment systems and methods are able to generate more accurate and personalized risk scores for users.

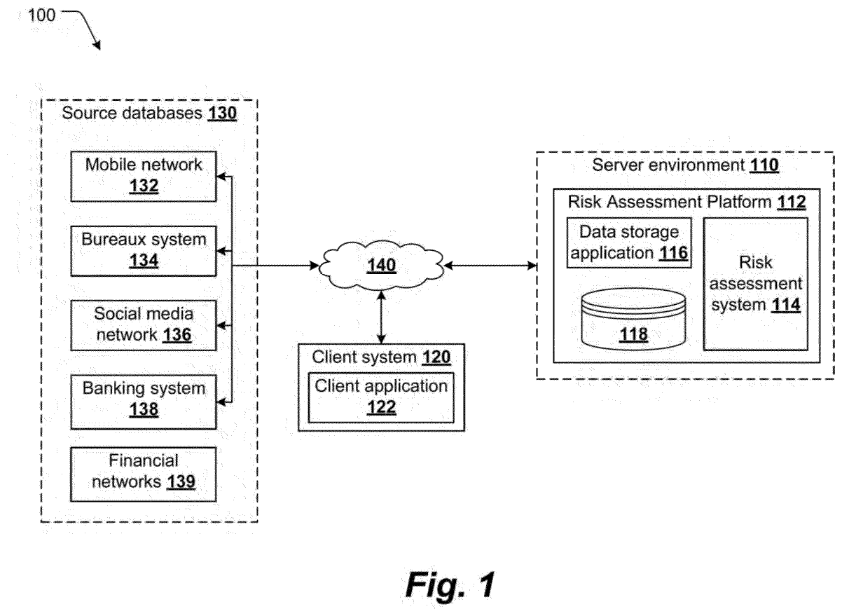

These and other aspects of the systems and methods will be described in detail with references to FIG. 1-9 below.

### Example Systems

FIG. 1 is a diagram depicting a networked environment 100 in which various features of the present disclosure may be implemented. Embodiments of the present disclosure are described with reference to a risk assessment platform, which includes server- and client-side applications which operate together to perform the processing described herein.

In particular, as depicted in FIG. 1, the environment includes a server environment 110, a client system 120, and a plurality of source databases 130. The server environment 110, client system 120, and source databases 130 communicate with each other via one or more communications networks 140, for example the Internet.

Generally speaking, the server environment 110 includes a risk assessment platform 112 on which applications that provide server-side functionality to client applications such as client application 122 (described below) execute. In the present example, the server environment 110 includes a risk assessment application 114, and a data storage application 116.

The risk assessment application 114 operates to provide a client application endpoint that is accessible over the communications network 140. For example, where the risk assessment application 114 serves web browser client applications, the risk assessment application 114 is hosted by a web server which receives and responds (for example) to HTTP requests. Where the risk assessment application 114 serves native client applications, the risk assessment application 114 is hosted by an application server configured to receive, process, and respond to specifically defined API calls received from those client applications. The server environment 110 may include one or more web server applications and/or one or more application server applications allowing it to interact with both web and native client applications.

Generally speaking, the risk assessment application 114 facilitates various functions related to training ML models to generate risk assessment scores and utilizing the trained ML models to determine risk assessment scores in real time based on user requests. This may include, for example, receiving, processing, and analyzing source data, creating ML sub-models and training them, and providing the output from these sub-models to an ensemble model to generate the final risk assessment scores.

The risk assessment application 114 may also facilitate additional functions that are typical of server systems—for example, user account creation and management, user authentication, and/or other server side functions. These functionalities may be provided by individual applications, e.g., an account management application (not shown) for account creation and management, etc.

The specific modules and operations of those modules of the risk assessment application 114 will be described in detail later.

The data storage application 116 operates to receive and process requests to persistently store and retrieve data in data storage 118 that is relevant to the operations performed/services provided by the server environment 110. Such requests may be received from the risk assessment application 114, other server environment applications, and/or in some instances directly from client applications such as the client application 122.

Data relevant to the operations performed/services provided by the server environment may include, for example, data from source databases 130, training data, risk assessment data, user account data, and/or other data relevant to the operation of the risk assessment application 114. The data storage 118 is provided by one or more data storage devices that are local to or remote from the risk assessment platform 112. The example of FIG. 1 shows data storage 118 in the server environment 110. The data storage 118 may be, for example one or more non-transient computer readable storage devices such as hard disks, solid state drives, tape drives, or alternative computer readable storage devices, such as cloud object storage.

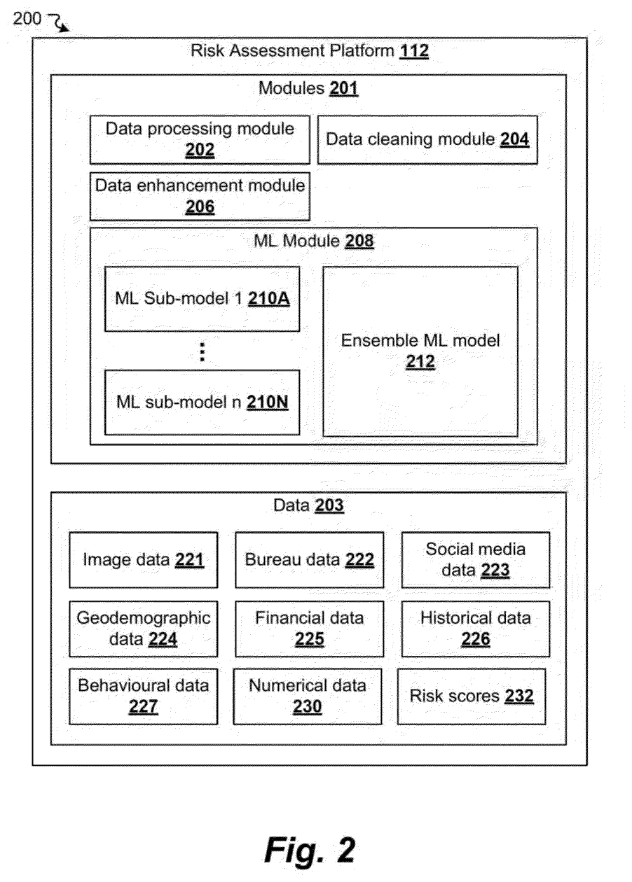

In the server environment 110, the risk assessment application 114 persistently stores data (as described below with respect to FIG. 2) to the data storage 118 via the data storage application 116. In alternative implementations, however, the risk assessment application 114 may be configured to directly interact with the data storage 118 to store and retrieve data, in which case a separate data storage application may not be needed.

As noted, the risk assessment application 114 and data storage application 116 run on (or are executed by) risk assessment platform 112. The risk assessment platform 112 includes one or more computer processing systems. The precise number and nature of those systems will depend on the architecture of the server environment 110.

For example, in one implementation a single risk assessment application 114 runs on its own computer processing system and a single data storage application 116 runs on a separate computer processing system. In another implementation, a single risk assessment application 114 and a single data storage application 116 run on a common computer processing system. In yet another implementation, the server environment 110 may include multiple server applications running in parallel on one or multiple computer processing systems.

Although the server environment 110 only depicts a risk assessment application 114 and a data storage application 116 in FIG. 1, this may not be the case in actual implementation. In implementation, the server environment 110 may include other applications as well, e.g., a service application (not shown), that is configured to provide a service based on the risk scores predicted by the risk assessment application 114. In some examples, the server environment may be configured to receive short-term loan requests from users. In such examples, the service application may be configured to receive risk scores from the risk assessment application 114 and determine loan amounts to be provided to requesting users. The loan amount may depend on the amount requested by the user and the risk score of the user. For example, if the risk score is low (indicating that the probability of the user defaulting on the loan is low), the service application may approve a loan amount close to or equal to the requested amount (e.g., 90-100% of the requested amount). On the other hand, if the risk score is high (indicating that the probability of the user defaulting on the loan is high), the service application may approve a loan amount much lower than the requested amount (e.g., 20% of the requested amount).

The client system 120 may be any computer processing system which is configured or is configurable to offer client-side functionality. A client system 120 may be a desktop computer, laptop computers, tablet computing device, mobile/smart phone, or other appropriate computer processing system.

The client system 120 hosts the client application 122 which, when executed by the client system 120, configures the client system 120 to provide client-side functionality/interact with server environment 110 or more specifically, the risk assessment application 114 and/or other application provided by the server environment 110. Via the client application 122, a user can perform various operations described herein, such as sending a request for a risk assessment to the risk assessment platform 112, viewing a user account, checking balances owed by the user to a lender, etc. Such operations may be performed solely by client application 122, or may involve the client application 122 communicating with the server environment 110 for processing to be performed there (e.g. by the risk assessment application 114).

The client application 122 may be a general web browser application which accesses the risk assessment application 114 via an appropriate uniform resource locator (URL) and communicates with the risk assessment application 114 via general world-wide-web protocols (e.g. http, https, and ftp). Alternatively, the client application 122 may be a native application programmed to communicate with risk assessment application 114 using defined API calls.

A given client system such as 120 may have more than one client application 122 installed and executing thereon. For example, a client system 120 may have a (or multiple) general web browser application(s) and a native client application.

The source databases 130 may include a variety of databases that the server environment 110 can receive source data from. Some examples of these external data sources include, e.g., mobile network databases 132, Bureau system databases 134, social media databases 136, bank databases 138, and financial databases 139.

Mobile network databases 132 are associated with mobile networks and include user account information about mobile device usage. This information may include, for example, but not limited to information about users' mobile network service providers, mobile data usage rate, mobile data limit, days on current mobile plan, history of products and services, applications on mobile device, mobile device type, mobile data usage records, and call logs.

Social media databases 136 are associated with social media networks and include user account information about social media usage. This information may include, for example but not limited to, information about users' number of connections, post history, number of photos, contact details, location, address, login history, number of messages, user engagement, and/or information about third party connected applications.

Bureau system databases 134 maintain financial data about users collected from various financial institutes and banks. The information included in such databases 134 may include information about a user's current credit score, history of credit score, history of loans and repayments, number of accounts, types of accounts, etc. It may also include information about current and previous address information.

Bank databases 138 are associated with banks and maintain banking user account information. The information maintained by such databases may include, for example, a history of bank statements, loans, credit scores, loan history, repayment history, delinquency history, number of credit cards, and other financial information. It may also include specific spending information such as location of spending, amount, and category of expenditure. It may also include other metadata such as type and product of bank account and balance of each account.

Financial databases 139 are associated with financial institutions, online and mobile payment platforms and maintain financial user account information. The information may include, spending history, repayment history, delinquency history, transaction history, loan history, credit scores, number of linked credit cards, and spending information such as location, amount, and/or category of expenditure. It may also include information about third party connected applications.

Communication between the applications and computer processing systems of the server environment 110 may be by any appropriate means, for example direct communication or networked communication over one or more local area networks, wide area networks, and/or public networks (with a secure logical overlay, such as a VPN, if required).

In the environment of FIG. 1, and the embodiments described below, various processing is described as being performed by different applications and modules thereof—e.g. the risk assessment application 114, the data storage application 116, and/or the client application 122. It will be appreciated, however, that in most cases the processing that is described could be performed by alternative applications or modules, and that such applications or modules may run either at a client system such as 120 or at a server environment such as 110. As one example, the techniques described herein may be provided as part of a stand-alone application in which case all processing and data storage may be performed by a single computer processing system (which is configured by one or more applications or modules).

FIG. 2 is a block diagram of an example risk assessment platform 112, illustrating various modules of the risk assessment platform 112. As described previously, the risk assessment platform receives source data from the one or more source databases 130 and uses this data to train its risk assessment machine-learning model to generate risk scores. The risk assessment platform also receives risk assessment requests from users in real time and generates risk scores in response to such requests. To do so, the risk assessment platform 112 includes one or more modules 201 and data 203. The modules 201 are part of the risk assessment application 114 and the data 203 is stored in the data storage 118.

The modules 201 include a data processing module 202, a data cleaning module 204 and a data enhancement module 206. In addition, the risk assessment platform includes an ML module 208 that includes a plurality of sub-models 210A-210N (which are generally referred to as sub-models 210 in this disclosure), and an ensemble model 212.

The data processing module 202 is configured to extract data from client systems 120 and/or source databases 130, and determine whether the extracted data is static or time series data. Time series data is data that may continuously update over time such as a cumulative amount of spent money or credit score. Examples of time series data include credit and debits in a user's bank account and the user's interactions with the application over time. Static data, on the other hand, may be data that remains unchanged or may only change under certain circumstances independent of time. For example, static data may include data such as a bank account held by a user, the country of residence of a user, the computing device utilized by a user, the internet network utilized by a user, vendors and shopping categories, etc. Although a user may change their bank account, country of residence or computing device, these changes occur infrequently and do not increment or change based on time.

The data cleaning module 204 is configured to receive the static and time series data from the data processing module 202 and process the data. Data processing may include normalizing the data from the source databases 130 (e.g., if multiple databases provide the same information but in slightly different formats), error correcting (that is identifying the more correct piece of data when it comes from difference sources), categorizing the data (adding internal category tags to the data), temporally de-duplicating data (aggregating temporal data into set time frames as different external sources may use different methods of recording the timestamp of an event. For example an external source may record the timestamp of a message when it is sent whereas another external source may record the timestamp of the message when it is received), imputing missing data (that is filling in information that may be missing from data such as average expenditure), and de-duplicating records (that is removing duplicate events from the data as external sources may send the same or similar data multiple times for the same event).

The data enhancement module 206 is configured to enhance the processed and cleaned data. To do so, the data enhancement module 206 analyses the data to detect patterns and build more complex inputs. For example, the data enhancement module 206 determines macro trends and seasonal trends based on the data for all users and determines individual user trends (e.g., with respect to spending and/or saving behaviors). These macro, seasonal, and individual trends may be added to the user data records to generate enhanced user data records. The data enhancement module also includes data categorization, i.e. adding internal tags to the data relevant to risk assessments.

The ML module 208 receives the enhanced data records, divides this data into subsets, and creates sub-models associated with each of the subsets. The subsets of data may be identified based on different attributes or variables of the data. For example, the ML module 208 may create a subset of data based on seasonal trends, spending behaviors, phone types, and bank type. Each sub-model may be trained to determine risk scores. In some examples, the sub-models 210 may be based on different types of ML models. For instance, one or more sub-models may be based on generalized additive models, whereas other sub-models 210 may be based on gradient boosted tree or neural network models.

The ML module 208 further includes an ensemble model 212, which receives the risk scores from the different sub-models 210 and generates final risk scores.

The data 203 includes input data such as image data 221, bureau data 222, social media data 223, geodemographic data 224, financial data, 225, historical data 226, behavioral data 227, as well as data generated by the risk assessment platform such as numerical data 230, and risk scores 232.

The image data 221 includes images associated with user accounts. This may include, for example, images submitted by users (e.g., using client systems 120) such as scans of identity documents and bank statements.

The bureau data 222 may include information received from the bureau databases 134 and may include information such as a user's current credit score, history of credit score, account information and summaries of loans and repayments made by users to banks and other financial institutes. It may also include information about current and previous address information for users. An example excerpt of the bureau data is provided in the table below. In this example, for each unique user ID, the data includes the individual's credit score, address, loan history, and date of birth. It will be appreciated that this is merely an example and that the bureau data can include other data received from the bureau database 134 in addition to or in place of the data displayed in the table.

| | Credit | | | |
|---|---|---|---|---|
| User ID | Score | Address | Loan History | Date of Birth |
| 123456 | 700 | 123 | [{“loanId”: “L123456” | 10 Oct. 1999 |
| | | Street, | “loanAmount”: 5000, | |
| | | Sydney | “startDate”: “2022-01-15”, | |
| | | Australia | “endDate”: “2022-07-15”, | |
| | | | “status”: “repaid”, | |
| | | | “repaymentHistory”: | |
| | | | [{“paymentDate”: | |
| | | | “2022-02-15”, | |
| | | | “amountPaid”: 1000, | |
| | | | “status”: “paid”}, | |
| | | | {“paymentDate”: “2022- | |
| | | | 03-15”, | |
| | | | “amountPaid”: 4000, | |
| | | | “status”: “paid”}] | |

Social media data 223 includes data received from the social media databases 136. This data may include, for example, information about a users' number of connections, post history, number of photos, contact details, location, address, login history, number of messages, user engagement and third party connected applications. An example excerpt of the social media data is provided in the table below. In this example, for each unique user ID, the data includes the number of connections the user has, the user's location, their login history, and the number of posts created by the user. It will be appreciated that this is merely an example and that the social media data can include other data received from the social media databases 136 in addition to or in place of the data displayed in the table.

| | # | | | Number of |
|---|---|---|---|---|
| User ID | Connections | Location | Login History | Posts |
| 123456 | 400 | Sydney, | [{timestamp: 123231233, | 65 |
| | | Australia | type: login}, | |
| | | | {timestamp: | |
| | | | 123231460, | |
| | | | type: logout}, | |
| | | | {timestamp: | |
| | | | 1232319700, | |
| | | | type: login},...] | |

Geodemographic data 224 may include for each unique user their geodemographic information including, e.g., their location history, country of residence, address, age, gender, etc. this data may be populated based on data received from users (e.g., via the client systems 120) or from one or more source databases 130.

Financial data 225 includes data received from the financial databases 139. This data may include, for example, spending history, transaction history, loan history, credit scores, number of linked credit cards, and spending information such as location, amount, and category of expenditure. It may also include information about third party connected applications. An example excerpt of the financial data is provided in the table below. In this example, for each unique user ID, the data includes the user's address, all credit/debit cards linked to that user, the user's spending history on the linked cards, and the user's email address. It will be appreciated that this is merely an example and that the financial data 225 can include other data received from the financial databases 139 in addition to or in place of the data displayed in the table.

| User Id | Address | Linked Cards | Spending History | Email |
|---|---|---|---|---|
| 123456 | 123 Street, | [{ | [{ | email@e |
| | Sydney | “cardId”: | “transactionId”: | mail.com |
| | Australia | “98765321”, | “001”, | |
| | | “cardType”: | “cardId”: | |
| | | “Visa”, | “987654321”, | |
| | | “expirationDate”: | “amount”: 100, | |
| | | “12/25”, | “merchant”: “abc”, | |
| | | “isPrimary”: true | “transactionDate”: | |
| | | }, | “2023-12-01” | |
| | | { | }] | |
| | | “cardId”: | | |
| | | “123456789”, | | |
| | | “cardType”: | | |
| | | “MasterCard” | | |
| | | “expirationDate”: | | |
| | | “08/24”, | | |
| | | “isPrimary”: false | | |
| | | }] | | |

Historical data 226 includes a history of loans and transactions made by users with the business associated with the risk assessment platform 112. It includes, for example, previously requested loan amounts, previously approved loan amounts, previously rejected loan requests, time stamps, history of repayments of those loan amounts, whether there were any defaults in the payments, etc.

Behavioral data 227 may include data collected from client systems 120. For example, the client application 122 may collect device and/or network data from the user's client system 120 and communicate this data to the risk assessment platform 112, which adds the data to the behavioral data 227. In some examples, this may include one or more of number of applications downloaded on the user's device, the types of the applications downloaded on the user device, the device type, the device identifier, the communication network utilized by the client systems 120, and the battery (e.g., if the client device is a portable device).

Numerical data 230 is data created by risk assessment platform 112 when training the ML modules 208 and/or generating risk scores. In some examples, the numerical data includes data generated by the data cleaning module 204, the data enhancement module 206 and ML module 208. In some examples, numerical data is vector embeddings of source data records.

Risk scores 232 is data created from the ensemble ML model 212 that represents the risk scores generated by the ML modules 208 for any incoming requests. For each request, the risk scores data may maintain a unique risk request identifier, a user identifier of the user making the request, and a risk score generated by the risk assessment platform 112.

As noted, the techniques and operations described herein are performed by one or more computer processing systems.

By way of example, client system 120 may be any computer processing system which is configured (or configurable) by hardware and/or software—e.g. client application 122—to offer client-side functionality. A client system 120 may be a desktop computer, laptop computer, tablet computing device, mobile/smart phone, or other appropriate computer processing system.

Similarly, the applications of server environment 110 are also executed by one or more computer processing systems (e.g., platform 112). Server environment computer processing systems will typically be server systems, though again may be any appropriate computer processing systems.

### Example Computer System

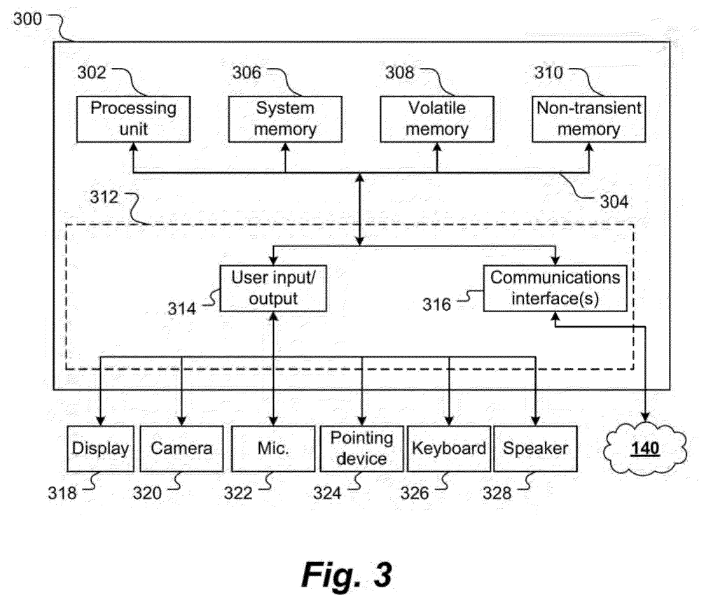

FIG. 3 provides a block diagram of a computer processing system 300 configurable to implement operations described herein. The computer processing system 300 is a general purpose computer processing system. As such a computer processing system in the form shown in FIG. 3 may, for example, form a standalone computer processing system, form all or part of risk assessment platform 112, including data storage 118, or form all or part of the client system 120 (see FIG. 1). Other general purpose computer processing systems may be utilized in the system of FIG. 1 instead.

It will be appreciated that FIG. 3 does not illustrate all functional or physical components of a computer processing system. For example, no power supply or power supply interface has been depicted, however system 300 either carries a power supply or is configured for connection to a power supply (or both). It will also be appreciated that the particular type of computer processing system will determine the appropriate hardware and architecture, and alternative computer processing systems suitable for implementing features of the present disclosure may have additional, alternative, or fewer components than those depicted.

The computer processing system 300 includes at least one processing unit 302. The processing unit 302 may be a single computer processing device (e.g. a central processing unit, graphics processing unit, or other computational device), or may include a plurality of computer processing devices. In some instances, where a computer processing system 300 is described as performing an operation or function all processing required to perform that operation or function will be performed by processing unit 302. In other instances, processing required to perform that operation or function may also be performed by remote processing devices accessible to and useable by (either in a shared or dedicated manner) the computer processing system 300.

Through a communications bus 304 the processing unit 302 is in data communication with one or more machine readable storage (memory) devices which store computer readable instructions and/or data which are executed by the processing unit 302 to control operation of the processing system 300. In this example the computer processing system 300 includes a system memory 306 (e.g. a BIOS), volatile memory 308 (e.g. random access memory such as one or more DRAM modules), and non-transient memory 310 (e.g. one or more hard disk or solid state drives).

The computer processing system 300 also includes one or more interfaces, indicated generally by 312, via which computer processing system 300 interfaces with various devices and/or networks. Generally speaking, other devices may be integral with the computer processing system 300, or may be separate. Where a device is separate from the computer processing system 300, connection between the device and the computer processing system 300 may be via wired or wireless hardware and communication protocols, and may be a direct or an indirect (e.g. networked) connection.

Wired connection with other devices/networks may be by any appropriate standard or proprietary hardware and connectivity protocols. For example, the computer processing system 300 may be configured for wired connection with other devices/communications networks by one or more of: USB; eSATA; Ethernet; HDMI; and/or other wired connections.

Wireless connection with other devices/networks may similarly be by any appropriate standard or proprietary hardware and communications protocols. For example, the computer processing system 300 may be configured for wireless connection with other devices/communications networks using one or more of: BlueTooth; WiFi; near field communications (NFC); Global System for Mobile Communications (GSM), and/or other wireless connections.

Generally speaking, and depending on the particular system in question, devices to which the computer processing system 300 connects—whether by wired or wireless means—include one or more input devices to allow data to be input into/received by the computer processing system 300 and one or more output devices to allow data to be output by the computer processing system 300. Example devices are described below, however it will be appreciated that not all computer processing systems will include all mentioned devices, and that additional and alternative devices to those mentioned may well be used.

For example, the computer processing system 300 may include or connect to one or more input devices by which information/data is input into (received by) the computer processing system 300. Such input devices may include keyboard, mouse, trackpad, microphone, accelerometer, proximity sensor, GPS, and/or other input devices. The computer processing system 300 may also include or connect to one or more output devices controlled by the computer processing system 300 to output information. Such output devices may include devices such as a display (e.g. a LCD, LED, touch screen, or other display device), speaker, vibration module, LEDs/other lights, and/or other output devices. The computer processing system 300 may also include or connect to devices which may act as both input and output devices, for example memory devices (hard drives, solid state drives, disk drives, and/or other memory devices) which the computer processing system 300 can read data from and/or write data to, and touch screen displays which can both display (output) data and receive touch signals (input). The user input and output devices are generally represented in FIG. 3 by user input/output 314.

By way of example, where the computer processing system 300 is the client system 120 it may include a display 318 (which may be a touch screen display), a camera device 320, a microphone device 322 (which may be integrated with the camera device), a pointing device 324 (e.g. a mouse, trackpad, or other pointing device), a keyboard 326, and a speaker device 328.

The computer processing system 300 also includes one or more communications interfaces 316 for communication with a network, such as network 140 of environment 100 (and/or a local network within the server environment 110). Via the communications interface(s) 316, the computer processing system 300 can communicate data to and receive data from networked systems and/or devices.

The computer processing system 300 may be any suitable computer processing system, for example, a server computer system, a desktop computer, a laptop computer, a netbook computer, a tablet computing device, a mobile/smart phone, a personal digital assistant, or an alternative computer processing system.

The computer processing system 300 stores or has access to computer applications (also referred to as software or programs) —i.e. computer readable instructions and data which, when executed by the processing unit 302, configure the computer processing system 300 to receive, process, and output data, or in other words to configure the computer processing system 300 to be data processing system with particular functionality. Instructions and data can be stored on non-transient memory 310. Instructions and data may be transmitted to/received by the computer processing system 300 via a data signal in a transmission channel enabled (for example) by a wired or wireless network connection over an interface, such as communications interface 316.

Typically, one application accessible to the computer processing system 300 will be an operating system application. In addition, the computer processing system 300 will store or have access to applications which, when executed by the processing unit 302, configure system 300 to perform various computer-implemented processing operations described herein. For example, and referring to the networked environment of FIG. 1 above, server environment 110 includes one or more systems which run the risk assessment application 114, and the data storage application 116. Similarly, client system 120 runs the client application 122.

In some cases part or all of a given computer-implemented method will be performed by the computer processing system 300 itself, while in other cases processing may be performed by other devices in data communication with the computer processing system 300.

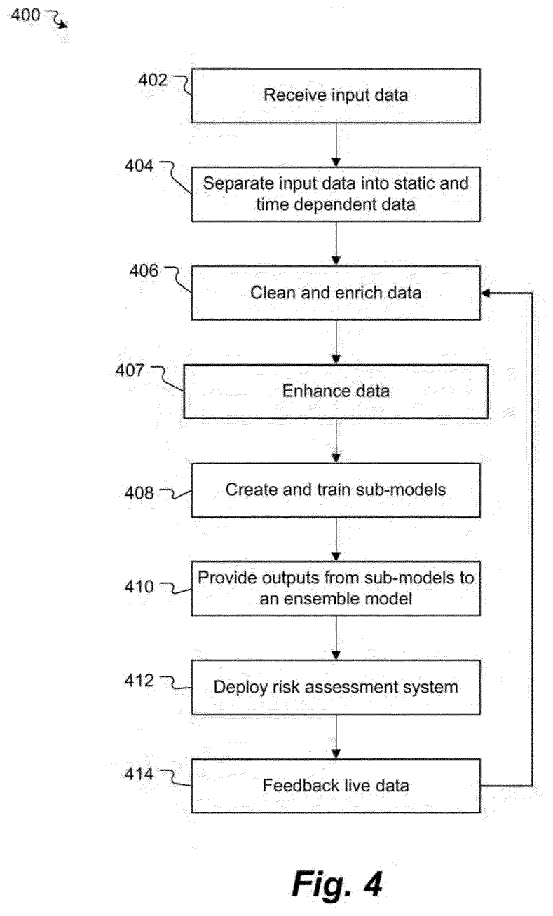

FIGS. 4 to 9 depict methods that may be performed by a data processing system. The arrangement of steps in these figures is not intended to limit the disclosure to only the order of step shown, or intended to limit the disclosure to only serial processing for any steps.

### Example Methods

FIG. 4 is a flowchart illustrating an example method 400 performed by the risk assessment platform for training the ML modules 208.

The method commences at step 402, where the risk assessment platform 112 receives source data. The source data may be received from source databases 130, the platform's own internal database (e.g., historical data), and/or the client systems 120. For example, the risk assessment platform 112 may receive network data, bureau data 222, social media data 223, and financial data 225 from the mobile network databases 132, the bureau databases 134, the social media databases 136, the banking databases 138, and the financial databases 139, respectively. It may receive image data 221 and behavioral data 227 from the client systems 120 and it may receive historical data 226 from its own internal data storage 118. The source data may be received and stored in the data storage 118, for example, as data 221-227.

In some embodiments, the data from each data source is provided for users that have previously or currently requested a service (e.g., a loan) from the risk assessment platform 112. Each data source may span over different predefined time periods—e.g., 3 months, 6 months, one year, three years, etc. Further the data from some data sources (e.g., network data) may only include one-time information (e.g., at the time a user had or has requested a service), whereas data from other data sources may include information from the entire predefined time period.

The risk assessment platform 112 may maintain user records for each individual user and request data from the various data sources periodically (e.g., every week, every month, etc.) for these users. Each time data is received from a data source, it is added to the user record such that the risk assessment platform 112 has information from various sources related to the users over time. In some embodiments, the risk assessment platform 112 may provide full legal names of users and other identifying information such as their date of birth and/or address and request the source databases 130 to perform searches in their databases for certain time periods and forward relevant data associated with those users in those time periods (e.g., if the databases include any data for the requested users).

Further, in some embodiments, the data from each source is received in the form of data records. For example, the financial data may be in the form of multiple financial data records. The data from the social media databases may be in the form of multiple social media data records, and so on. An example financial data record for a user is provided in the table below.

```
  {
    “id”: “00186983-dad8-4427-9ac8-4e486b6c6d6d”,
    “accountId”: “0707940f-1068-4f8f-bacc-34084f98ddf9”,
    “institutionId”; “AU00901”,
    “description”: “Card Purchase PAYW PALMWOODS BAKERY\\PALMWOOD S
QLD ”,
    “descriptionAlias”: null,
    “transactionDate”: “2023-10-25T00:00:00”,
    “amount”; −16.5,
    “balance”: 69.54,
    “class”: “Payment”,
    “subClassCode”: null,
    “subClassTitle”: null,
    “internalCategorisation”: “RestaurantsAndCafes”,
    “status”; “Posted”,
    “enrichmentData”: {
      “merchant”: {
        “BusinessName”: “PAYW PALMWOODS BAKERY”,
        “Website”: null,
        “PhoneNumber”: {
          “Local”: null,
          “International”: null
        }
      },
      “location”: {
        “Geometry”: {
          “Latitude”: null,
          “Longitude”: null
        },
        “Suburb”: “PALMWOODS”,
        “RouteNo”: null,
        “State”: null,
        “FormattedAddress”: null,
        “PostalCode”: null,
        “Country”: null,
        “Route”: null
      },
      “category”: {
        “Anzsic”: {
          “Group”: {
            “Title”; “Bakery Product Manufacturing”,
            “Code”: “117”
          },
          “Division”: {
            “Title”: “Manufacturing”,
            “Code”: “C”
          },
          “Class”: {
            “Title”: “Bakery Product Manufacturing (Non-factory based)”,
            “Code”: “1174”
          },
          “Subdivision”: {
            “Title”: “Food Product Manufacturing”,
            “Code”: “11”
          }
        }
      },
      “links”: null,
      “vendor”: “vendorName”
    }
  }
```

Further still, it will be appreciated that multiple data snapshots may exist for a single user. For example, if a user requests the service multiple times, each time the user makes a request, data from different sources is collected for the user and added to the user record. The data collected at any given time is then considered a data snapshot for that user, which may include multiple data records from different sources, and multiple such data snapshots may be available at 402 for multiple users. In this disclosure, each separate data snapshot is referred to as a user data record.

At step 404, data processing module 202 classifies the received data as either static data or time series data. For example, data such as addresses, date of births, locations, networks, client device identifiers, etc., which does not usually change with time can be classified as static data. Alternatively, data such as monthly bank statements, number of social media posts, credit scores, etc., that usually change with time is classified as time series data. This classification is performed as static and time series data require different types of data processing. For example, as static data does not change often, it is processed and cleaned less often than time series data. Time series data on the other hand is received daily and is often new data and therefore processed more often.

At step 406, data cleaning module 204 performs a data cleaning and enrichment process on the static and time series data. The data cleaning is performed to normalize the data received from different source databases or client systems. For example, the system may receive bank statements from multiple source databases or client systems and the different sources may provide the same information but in different formats and/or with different terminology. Data normalization ensures that all the data is converted to the same format using the same terminology—this can help de-duplicate data and improve the accuracy of the ML models to predict risk scores.

### Data Cleaning and Enrichment Process

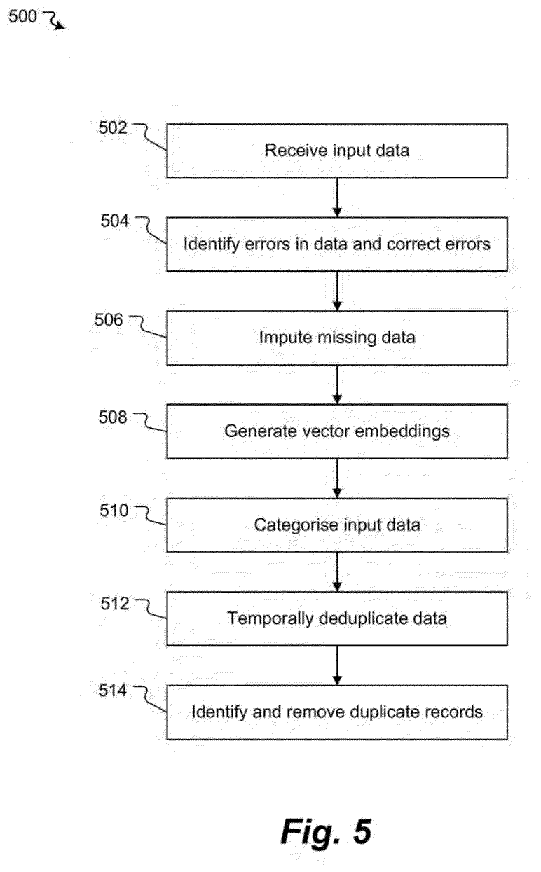

FIG. 5 is a flowchart of an example method for processing the source data. The method may be performed by the data cleaning module 204. It will be appreciated that although this method is described sequentially in a particular order, this may not be the case in all implementations. The sequence of operations may be modified. Further, two or more of these process steps may be performed simultaneously without departing from the scope of the present disclosure.

The method commences at step 502, where the data cleaning module 204 receives the source data from the data processing module 202. In particular, it may receive the source data records classified as static and/or time series data.

At step 504, a process of error correction is performed on both the static and time series source data records. As the source data records are obtained from various different sources, data records for the same transaction may be received from multiple sources. For example, a credit card repayment transaction record may be received as part of a bank account statement (from which the money was debited) and as part of a credit card statement (where the money was credited). Although these transaction records are related to the same activity, they are considered distinct transaction records according to aspects of the present disclosure. In some cases, the amounts, description, tags, and/or time stamps for these distinct transaction records that relate to the same activity may be different. As another example, some data sources may indicate that a user resides in suburb X, whereas other data sources may indicate that the user resides in suburb Y.

Accordingly, at step 504, the data cleaning module 204 identifies such data records that correspond to the same activity and determines whether the data in such data records match. Two records may correspond to the same record if sufficient information is the same (i.e. the transaction description, date, and amount are the same). If any of the data fields do not match up, the data cleaning module 204 corrects the non-matching data in such data records. If the non-matching data is a dollar value, the data cleaning module 204 may be configured to update the data records such that they both have either one of the values. Alternatively, it may calculate the average of the two dissimilar amounts and update both transaction records to include the calculated average value. If the non-matching data is an object, attribute, or a string (e.g., a transaction name, a transaction tag, and/or a transaction attribute), the data cleaning module 204 may utilize the object, attribute or string of one of the data records and update the other data record using the same object, attribute, or string. For example, if some data sources indicate that a user resides in suburb X, whereas other data sources indicate that the user resides in suburb Y, the data cleaning module 204 identifies these discrepancies in the data records for the user at this: step and corrects the errors—e.g., by using the most frequently used suburb as the correct suburb and replacing this value in other data records for the user that indicate a different suburb.

At step 506, the data cleaning module 204 imputes missing data records. In some cases, the data retrieved from the source databases 130 or client systems 120 may be incomplete—e.g. some financial data records may include information such as weekly expense on groceries whereas other financial data records may be missing this information. Similarly, some behavior data records received from some client devices may include information about the device's operating system whereas other behavior data records may not include such information. If the data cleaning module 204 determines that one or more data records are missing information that may be required by the system for downstream processing, the data cleaning module 204 imputes the missing data fields to such data records.

In some examples, if a data record is missing binary data (e.g., number of home loans), the data cleaning module 204 may add a predetermined default value, e.g., ‘0’, Alternatively, if the missing data is on a continuous scale, for example, “how much does the user spend on groceries weekly?” the data cleaning module 204 may fill the missing data with the average value for the population for that data item (e.g., A$200).

At step 508, the source data records are transformed into numerical data records. In particular, this step is performed on non-numeric data, e.g., text, images, etc. In one embodiment, a ML encoder/embedder may be utilized that transforms the source data records in the vector space and in particular into vectors or numbers often called “embeddings.” Typically, ML embedders convert words and/or sentences and other data into numbers that capture their meaning and relationships. They represent different data types as vectors (or points) in a multidimensional space, where similar words or sentences are converted into vector numbers that are clustered closer together in the multidimensional space. These numerical representations of data help the ML modules 208 understand and process the data records more effectively.

Many conventionally available word and sentence embedders like BERT, Word2Vec, GloVe, or Universal Sentence Encoder are trained to understand the meaning and relationships between words and sentences based on publically available text such as Wikipedia, newspapers, social media posts, etc. Accordingly, such conventional embedders are fairly accurate in determining the meaning and relationships between normally used words and sentences and converting these into vector embeddings. However, the data records utilized in the present disclosure are usually very different from normal words and sentences. For example, in financial documents such as bank statements, each transaction record is a separate entity that does not generally have a contextual relationship with other transaction records in the statement. Further, each transaction record in a financial statement may include alphanumeric text, hexadecimal numbers, abbreviated text, and special characters that may be difficult to understand for conventionally trained embedders.

To account for this, aspects of the present disclosure fine-tune a conventional embedder such that it can understand unconventional words, sentences, and/or records, determine the meaning and relationships in those unconventional words, sentences and/or records and generate meaningful vector embeddings that can be utilized by the ML modules 208. In particular, the embedder of the present disclosure is specifically trained to identify the type of alphanumeric text that appears in financial data records and assign meaning to it without need for context.

In some embodiments, a conventional embedder such as BERT, Word2Vec, GloVe, Universal Sentence Encoder is used, which is fine-tuned with a loss function, such as a cosine similarity function, which determines how similar or dissimilar different combinations of words and characters are.

In one example, the fine-tuning is performed using supervised tuning—which utilizes labeled or unlabeled training samples of the data records 203. Each training sample includes an actual transaction record. The output may be the word or sentence the transaction record should be converted into or the vector number that it should be converted into. The conventional embedder is fed thousands if not hundreds of thousands of such labeled or unlabeled training samples. Based on each training sample, the embedder adjusts the internal weights of its neural networks to be able to generate the desired output result. Once the embedder is trained, a few hundred test samples are provided to the embedder without any labels. If the embedder is able to generate the correct output for a threshold number or percentage (e.g., 96%) of the test samples, the embedder is considered fine-tuned. Otherwise, the embedder is retrained with additional training samples, until it generates the correct outputs for the threshold number of percentage of samples.

Once the embedder is trained, the source data records are provided to the embedder at step 508, and it converts the data into vector embeddings. The vector embeddings may be saved in the data storage, e.g., as numerical data 230. In some examples, the vector embeddings may be stored in relation to the data records they correspond to. The table below shows examples of two vector embeddings and their corresponding text descriptions.

| Text description | Numerical embedding |
|---|---|
| ‘Card Purchase | [ 0.02, 0.01, −0.03, 0.01, −0.01, 0.04, −0.01, 0. , −0.01, |
| PAYW | −0.03, 0,07, −0.05, −0.09, −0.05, 0. , −0.09, 0.03, 0.03, |
| PALMWOODS | 0.05, −0.03, 0.01, 0. , −0.02, −0.01, −0.05, −0.03, 0. , |
| BAKERY\\PALM | 0. , 0.03, −0.03, 0.04, 0.1 , 0.06, 0.02, 0.07, −0.05, |
| WOOD S QLD | 0.04, −0.01, 0.03, −0.07, −0.02, −0.05, −0.01, 0.01, 0. , |
| <DATE_TIME>’ | 0. , 0.02, 0.08, 0.03, 0,07. 0.01. 0.01, −0.01, −0.07, |
| | −0.1 , 0.01, −0.03, −0.01, 0,02, −0.06, 0. , 0.02, −0.04, |
| | 0.05, −0.06, −0.05, −0.01, 0,06, 0,01, −0.08, 0. , 0. , |
| | −0.03, −0.07, −0.01, 0.05, 0.09, 0. , 0.03, −0.02, −0.08, |
| | 0.02, 0.03, 0.02, 0.01, −0.01, 0. , 0.13, 0.02, −0.12, |
| | 0.06, 0. , −0.09. 0, , −0.07, −0.04, 0,03, −0.08, 0. , |
| | 0.04, 0.07. 0.08, 0. , 0. , 0.01, 0.01, −0.04, 0.09, |
| | 0.03, 0.01, −0.06, −0.03, −0.01, −0.05, 0. , 0.07, −0.02, |
| | −0.01, 0.06, 0. , 0. , 0. , −0.06, −0.05, −0.11, 0. , |
| | 0.07, 0. , −0.01, 0.04, 0. , −0.05, 0.06, −0.03, 0.09, |
| | −0.02, −0.01, 0.08, −0.01, −0.06, 0. , 0. , −0.06, 0.04, |
| | −0.09, 0. , 0.07, 0.05, −0.02, −0.04, −0.01, 0. , 0.06, |
| | 0.02, 0.02, 0.02, 0.12, 0.02, 0.11, −0.08, −0.04, −0.01, |
| | 0. , 0.06, 0.03, −0.03, −0.01, −0.07, 0. , 0. , 0. , |
| | −0.07, 0.01, −0.03, 0.03, 0.06, 0.07, 0.04, −0.08, 0.02, |
| | −0.02, 0. , 0. , −0.09, 0.02, 0.01, −0.03, −0.06, 0. , |
| | −0.07, −0.06, −0.05, −0.11, −0.04, -0,02, −0.08, −0.02, 0.05, |
| | 0. , 0.04, 0.11, −0.04, −0.02, 0.05, 0.01, 0.11, −0.01, |
| | 0.08, 0. , 0.04, −0.02, 0.05, 0.02, 0.02, 0.05, −0.01, |
| | 0. , −0.01, −0.08, 0.03, 0.09, 0.01, 0.06, 0. , −0.03, |
| | −0.04, 0. , 0.01, −0.02, 0.02, 0. , 0.06, 0.04, −0.04 |
| | −0.06, 0.07, 0.01, 0. , 0. , −0.01, 0.05, 0.03, 0.02, |
| | 0.01, −0.01, 0.09, 0. , −0.04, 0,04, 0.01, 0. , 0.05, |
| | −0.08, −0.05, 0.02, −0.12, −0.04, 0.07, −0.06, −0.05, −0.02, |
| | 0.12, 0.05, 0.09, 0. , 0. , −0.01, 0. , −0.05, −0.08, |
| | 0. , −0.07, 0.04, 0.02, −0.08, −0.01, −0.02, 0. , −0.04, |
| | 0.16, 0.05, 0.02, 0. , −0.05, −0.04, 0.02, 0. , 0.04, |
| | 0.09, 0. , 0.04, −0.02, 0.01, −0.03, −0.06, 0.11, 0.01, |
| | 0.05, 0. , 0.02, 0.05, 0.01, −0.01, −0.09, 0.01, −0.05, |
| | 0.01, 0.04, −0.05, 0. , 0.01, −0.03, 0. , −0.08, −0.11, |
| | 0.04. 0. , 0. , −0.02, 0. , 0. , 0, , −0.01, 0.06, |
| | −0.02, −0.03, 0.07, 0.03, −0.04, 0. , −0.01, 0.01, −0.05, |
| | −0.05, −0.02, −0.05, 0. , −0.04, −0.01, −0.07, 0.01, −0.01, |
| | 0.08, 0.02, −0.1 , 0.05, 0.08, 0.04, 0.06, 0.01, 0. , |
| | 0.04, 0.06, −0.01, 0. , −0.05, −0.09, 0. , −0.06, 0.06, |
| | 0. , −0.01. −0.03, −0.03, 0.01, 0.03, −0.05, −0.01, 0.03, |
| | 0.03, −0.01, 0.02, 0.05, −0.06, −0.11, −0.02, 0.02, −0.03, |
| | 0.06, 0.01, 0.06, −0.07, −0.02, −0.01] |
| ‘PAYW | [ 0.04, 0. , 0. , 0,04, −0.02, 0.03, −0.03, −0.03, −0.07, |
| WOOLWORTHS/ | −0.01, 0.02, −0.06, −0.1 , −0.03, 0. , −0.05, −0.06, −0.06, |
| 2 BUNYA ST | 0.07, 0.02, −0.02, −0.01, −0.04, 0. , −0.05, −0.04, 0. , |
| MALENY | 0. , 0. , −0.02, 0.04, 0.04, 0.08, 0. , 0.03, −0.05, |
| <DATE_TIME> | 0.1, −0.05, 0.02, 0.01, −0.05, −0.09, −0.05, 0. , 0. , |
| Card Purchase’ | 0. , 0.06, 0.07, 0. , 0.08, 0. , 0.04, 0.03, −0.02, |
| | −0.02, 0.02, −0.04, −0.02, 0. , −0.05, 0. , 0.01, −0.06, |
| | 0.01, −0.04, −0.02, −0.05, 0.04, 0.01, −0.06, 0.02, 0. , |
| | −0.01, −0.03, 0.01, 0.07, 0.06, −0.07, 0.02, 0.01, −0.12, |
| | −0.02, 0.06, 0.03, −0.01, −0.02. 0.01, 0.06, 0.01, −0.09, |
| | 0.07, 0. , 0. , 0.02, −0.01, −0.02, 0.05, 0. , −0.01, |
| | 0.05, 0.06, 0.01, −0.03, −0.01, 0.03, 0. , −0.03, 0.09; |
| | 0. , −0.03, −0.02, −0.01, −0.05, −0.07, −0.01, 0.1 , −0.02, |
| | 0. , 0.06, 0.01, 0.04, 0.01, −0.02, −0.06, −0.15, −0.04, |
| | 0.04, 0. , −0.01, 0.01, 0. , −0.07, 0.08, −0.01, 0.04, |
| | −0.04, 0. , 0.05, −0.05, −0.01, 0. , −0.03, −0.02, 0.01, |
| | −0.03, 0.02, 0.1, 0.04, −0.04, 0. , 0.01, −0.02, 0.02, |
| | 0. , 0.03, −0.01, 0.14, 0.04, 0.1 , −0.06, −0.03, −0.04 |
| | 0. , 0.03, −0.01, −0.02, −0.01, 0. , 0.05, 0. , 0.01, |
| | −0.06, 0. , −0.01, 0.07, 0.03, 0. , 0.08, −0.05, 0. , |
| | −0.08, 0. , 0. , −0.1, 0.06, 0. , 0.03, −0.03, 0. , |
| | −0.07, 0.03, −0.13, −0.11, −0.04, 0. , −0.05, −0.07, 0.02, |
| | 0.01, 0.08, 0.09, −0.07, 0, 0.02, 0, 0.09, 0.06, |
| | 0.04, −0.01, 0.06, 0. , 0.08, −0.01, 0.04, 0.06, 0.02, |
| | −0.05, −0.01, −0.03, 0.04, 0.01, −0.08, 0.11, 0. , 0.02, |
| | −0.03, −0.02, 0.02, −0.02, 0, 0.05, 0.08, 0.08, 0.04, |
| | 0.02, 0.05, 0, 0.01, 0, −0.01, 0.05, 0. , 0.04, |
| | −0.06, 0.03, 0.06, −0.01, 0.03, 0.02, 0.01, 0.06, 0. , |
| | −0.04, 0. , 0. , −0.13, −0.09, 0.07, −0.05, 0. , 0.02, |
| | 0.14, 0.07, 0.04, −0.06, −0.01, 0, 0, −0.02, −0.07, |
| | 0. , −0.06, 0.07, 0.02 −0.03, −0.02, 0, 0, −0.04, |
| | 0.11, 0. , 0.02 −0.01, −0.01,−0.02, 0.03, 0. , 0.05, |
| | 0.03, −0.04, 0. , −0.11, 0.04, −0.09, −0.06, 0.05, 0.04, |
| | 0. , −0.05. 0. , 0.04, 0.05, 0.03, −0.05, −0.01, −0.04, |
| | 0.02, 0.08, 0. , −0.06, 0.08, 0. , 0. , −0.05, −0.04, |
| | 0.07 −0.02, −0.01, 0. , 0. , 0. , 0.01, −0.04, 0.11, |
| | 0.04, 0.01, −0.01, −0.02, −0.02, 0.02, 0.05, 0.04, −0.03, |
| | −0.08, −0.04, −0.06, 0. , −0.05, −0.02, −0.03, 0.03, −0.01, |
| | 0.08, 0.03, −0.11, 0.02, 0.1 , 0.04, 0.03, 0. , 0. , |
| | 0.05, 0. , −0.06, 0.09, −0.11, −0.11, 0.03, −0.03, 0.05, |
| | 0.02, −0.1 , −0.03, −0.03, 0.04, 0.01, −0.11, 0. , 0. , |
| | 0.01, 0.07, 0.01, 0.07, 0.05, −0.06, −0.02, 0. , −0.02, |
| | −0.03, 0.03, 0.02, −0.08, −0.02, 0. ] |

At step 510, a process of normalizing data categories is performed for the data records. Typically, data records, such as transaction records include a data/time stamp of when the transaction occurred or was completed, a name of the vendor associated with the transaction, and a transaction amount. Sometimes, the transaction records include additional information such as tags that describe the type of transaction that has occurred. For example, if a user has used their credit card at a “shopping” establishment, the financial institution may tag that transaction under a “retail” category. Alternatively, if an automatic debit transaction is recorded in a user's bank account statement for a gym membership, the financial institution may tag that transaction under a “health” category. These categories may be applied to help users determine their spending habits and may be provided to the risk assessment platform 112 as part of some data records. However, all banking institutions may not use the same category classification system. By way of example, one bank may categorize a transaction with the business Woolworths as ‘retail’ whilst another bank may categorize the same transaction as ‘supermarket’. Further still, some banking institutions may not provide category tags at all. Similarly, for other data records, such as user device type, some data sources may provide very specific device type information (e.g., iPhone 14 Pro Max), whereas others may provide more general information. Accordingly, it would be desirable to also categorize such types of information into normalized categories.

To address this, at step 510, the data cleaning module 204 normalizes category tags in transaction data records and/or includes tags if they are not present. In some embodiments, the data cleaning module 204 may utilize its own category classification system and may maintain a mapping between its categories and the common categories utilized by other vendors. For example, the risk assessment platform 112 may include a category “groceries” and it may map this internal category to vendor categories, such as ‘groceries’, ‘food’ and ‘necessities’. Similar mappings may be stored for all other internal categories and corresponding known vendor categories.

Accordingly, when normalizing the transaction categories, as a first step, the data cleaning module 204 may identify all the transaction records that include a vendor category tag and try to map those vendor category tags to its own internal category tags. If the data cleaning module 204 finds a match for one or more of the vendor category tags in the transaction records to its own internal category tags, it replaces the corresponding vendor category tags in the transaction records with the matching internal category tag.

For the transaction records where the data cleaning module 204 cannot map vendor tags to internal tags (e.g., because no mapping exists for the vendor tags in the internal category list or no vendor category is provided in the transaction record), the data cleaning module analyses the description of the corresponding transactions to determine whether it maps to any of the internal category tags. In one embodiment, RegEx (regular expressions) may be utilized for this analysis. RegEx compares the letters within the description to the internal category tags. If a match is found (e.g., a transaction description includes the word “gym” and “gym” is an internal category tag), the identified internal category tag is applied to the transaction record.

If even after the direct mapping and text analysis, some transaction records exist for which no internal category can be selected, the data cleaning module 204 can apply clustering techniques to determine the internal categories for such transaction records. In one example, the data cleaning module 204 may compare the vector number of untagged transaction records with vector numbers of other tagged transaction records. As described previously, vector numbers for similar data records (i.e., similar in meaning and/or relationship) are clustered closer to each other in the multidimensional vector space than dissimilar data records. Accordingly, the data cleaning module may utilize vector distances between untagged transaction records and tagged transaction records to determine the internal category tags for the untagged transaction record. For example, for a given untagged transaction record, the data cleaning module 204 may identify the closest neighboring tagged transaction record and apply the same internal category tag to the untagged transaction record as the closest neighboring tagged transaction record.

Step 510 has been described such that the data cleaning module 204 performs the mapping, text analysis and embedding analysis steps sequentially and only performs the next step in case a preceding step did not result in an internal category tag being associated with a transaction record. In other embodiments, although these steps may be performed sequentially, each step may be performed on all the transaction records. This may be done in order to identify categorization errors and correct them. For example, a vendor may incorrectly tag a grocery transaction as a pharmaceutical transaction, but because the risk assessment platform 112 may include its own “pharmaceutical” internal category tag, it may also incorrectly tag the transaction as a pharmaceutical transaction if it does not perform the other two steps. When the embedding analysis is performed on such incorrectly tagged transaction records, the data cleaning module 204 may determine that the transaction's embedding is closer to many embeddings that are associated with the “groceries” internal category tag than the “pharmaceutical” tag and it may correct the internal category tag based on this analysis.

At step 512, deduplication is performed. When data records are received from different source databases 130, different sources may timestamp an event differently. For example, one network may record a timestamp of an event when the network sends a message to the user, however another may record a timestamp of an event when the user receives the message. In another example, some banking systems may record a timestamp when a transaction occurs, whereas others may record a timestamp when the transaction is cleared or completed. The data cleaning module 204 identifies such temporally duplicate records by inspecting the timestamps of the data records and classifying the data records into different predefined timeframe bins (e.g., separated by an hour, by a day, etc.). The timeframes of the bins may depend on the type of data records. For example, for application data, the bin size may be an hour and for financial transactions the bin size may be a day.

The data cleaning module 204 may perform data deduplication on such temporal records by maintaining one record and deleting the others. For example if two data records exist for the same activity-one with a timestamp from 12 Jan. 2024 and another with a timestamp from 11 Jan. 2024, the data cleaning module 204 may delete one of the records (e.g., the one from 11 Jan. 2024) and keep the other one.

At step 514, record deduplication is performed. As described previously, data sources may provide the same or similar data records multiple times. Thus, there is a need to identify duplicate data and deduplicate it. Data records may be of three types-only text, only numbers, and a combination of text and numbers.

To identify duplicate records in text only data records, the data cleaning module 204 may examine the vector embeddings of the records. In particular, the data cleaning module 204 may identify very similar or the same vector embeddings (e.g., by performing cosine similarity on the vector embeddings) to determine if two or more records are the same or very similar. If any such records are identified, it may classify these as duplicate records.

To identify duplicate records in numbers only data records, the data cleaning module 204 may identify data records with exactly matching numbers to be duplicate records.

To identify duplicate records in records that include text and numbers, the data cleaning module may utilize a hybrid approach where it checks the embeddings of the transactions to identify similar records and then checks to see if the numbers of such records also match. If such records are identified they are classified as duplicate records.

Once the duplicate records are identified, they are deduplicated, e.g., by keeping only one of the duplicated records and deleting the rest.

### Data Enhancement

Returning to FIG. 4, in step 407, a data enhancement process is performed using data enhancement module 206. Data enhancement includes using advance methods to detect patterns in the user data records and generate complex data inputs to add to the user data records.

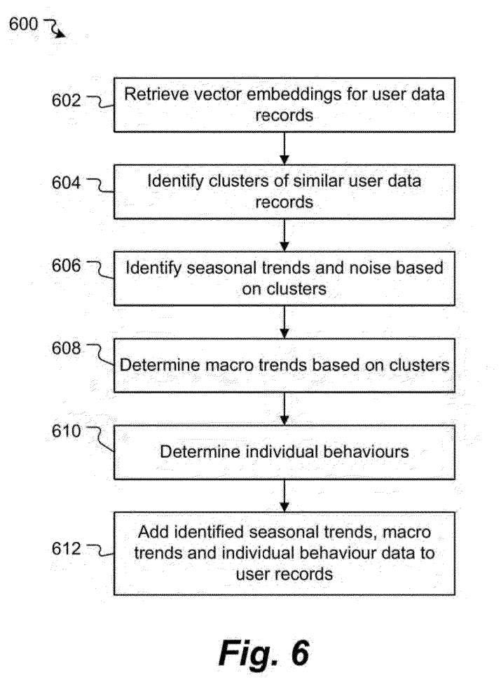

This step is described in detail with reference to FIG. 6, which is a flowchart depicting an example method 600 for enhancing data records. Method 600 may be performed by the data enhancement module 206.

Method 600 commences at step 602, where the data enhancement module 206 retrieves the vector embeddings for each of the user data records generated by the data cleaning module 204 at step 508.

At step 604, the data enhancement module 206, identifies clusters of similar user data records. In some embodiments, this identification is done based on the vector embeddings determined at step 508. In one example, cosine similarity may be performed on the vector embeddings to identify similar data records. Cosine similarity measures the cosine of the angle between two vectors in a multi-dimensional space. A cosine value of −1 indicates complete dissimilarity between vectors. A cosine value of 1 indicates complete similarity between vectors and a cosine value of 0 indicates orthogonality (i.e., no similarity). The data enhancement module 206 may calculate cosine similarity between all pairs of data records to create a cosine similarity matrix. This matrix generally represents the similarity between each pair of data points based on their cosine similarity.

The data enhancement module 206 may then select an arbitrary number of clusters (K) and then use the cosine similarity matrix as input to a K-means algorithm. In one example, the clusters can be determined based on the internal category tags used by the risk assessment platform 112. In other examples, clusters may be determined based any other feature or attribute—such as based on saving and spending behavior, which can be determines based on bank account balances and spending across all categories. The algorithm assigns data points from the matrix to one of the K clusters based on its cosine similarity to the cluster centroids. The K-means algorithm iteratively updates the cluster centroids and reassigns data points to clusters until convergence. Convergence occurs when the cluster assignments no longer change significantly. In some embodiments, an arbitrary cosine threshold value may be selected, e.g 0.8 and any vectors that have a cosine value of 0.8 or greater with any other vectors may be grouped in a cluster. Using this technique, the data enhancement module 206 may identify multiple such data clusters. Each cluster may be orthogonal or dissimilar to other clusters.

In other embodiments, other similarity determining and clustering techniques can be utilized such as Euclidean distance measurement and clustering.

At step 606, a time series analysis is performed on the various clusters of data records to separate out seasonal trends and noise. To do so, in one example, a temporal profile analysis is performed initially to extract temporal profiles of each cluster by aggregating or averaging the time series within each cluster (e.g., day, week, month, year, etc.). This provides an overview of the typical behavior of the time series in that cluster. A statistical analysis can then be performed on the temporal profiles to quantify characteristics such as mean, variance, seasonality, and trend within each cluster. Time series analysis techniques like auto-correlation, cross-correlation, and decomposition method can be applied for this. Next, events or anomalies can be identified within each cluster by examining deviations from the general patterns for a given time series. This may involve using anomaly detection techniques or statistical tests to identify significant deviations. For example, the data enhancement module may determine that during December and Christmas times, spending may be higher than other months. Similarly, it may determine that during school holidays, spending and borrowing increases. The time series analysis may also be performed at other frequencies (e.g., days of a week to identify any abnormal trends on certain days of the week, or hours of day to identify any abnormal trends at certain times of a day).

In some embodiments, the module 206 may compare the temporal profiles and patterns across different clusters to understand similarities and differences. This can provide insights into distinct temporal behaviors within different groups of time series. For example, based on this analysis, the data enhancement module 206 may determine behavioral trends over the entire population. For example, based on this analysis it may determine that people who spend an average of $x weekly on groceries also spend $x on retail shopping.

At step 608, data is aggregated across all users to identify macro trends. In one technique, the vector embeddings are aggregated over time to create a time series of average embeddings for each time period (e.g., day, week, month, etc.). Then, the average vector embedding may be computed for each time period to provide complex data such as average weekly income, monthly expenditure, etc. Additionally confidence intervals can be calculated around these averages to quantify uncertainty in the estimates. In some embodiments, trends may also be compared to publicly available data such as that provided by national statistical bureaus (e.g., the Australian Bureau of Statistics), to assess whether the identified trends are representative of the broader economy.

At step 610, the data enhancement module 206 compares the macro trends and seasonal trends with trends for individual users to determine individual recurring patterns. For example, the data enhancement module may analyze the time series trends for individual user data records to determine user level trends such as weekly income, monthly expenditure on mortgage, highest fortnightly expenses and so on. In some embodiments, determining the trends may include comparing the absolute difference between a user-related value and the average. For example, a user may spend $100 more on food than the average. In other embodiments, the comparison may be done in standard deviations. For example, a user may be considered to be 3 standard deviations greater than the average.

At step 612, the enhanced data is added to the user data records. Where trends are determined for individual users, the calculated trend data is converted into vector embeddings and added to the respective user data records. Where macro, behavioral and seasonal trend is determined, the calculated trends are converted into vector embedding and added to the user data records of all the individual users the trends relate to.

### Creating Sub-Models

Returning to FIG. 4, at step 408, the enhanced user data records are provided to the ML module 208, which creates two or more ML sub-models based on the data.

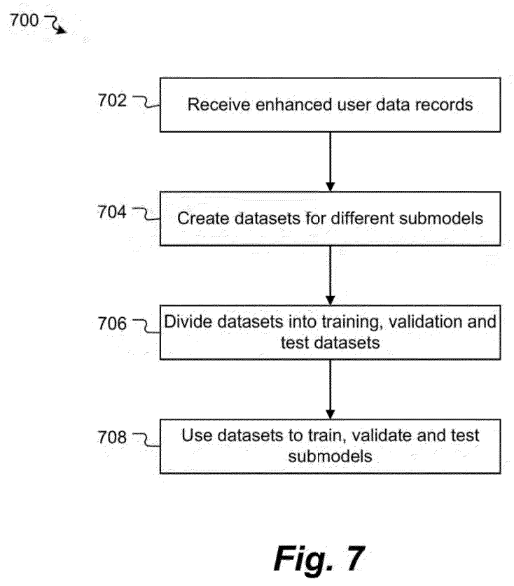

FIG. 7 is a flowchart illustrating an example method 700, performed by ML module 208 for creating the sub-models. Each sub-model may be configured to predict different flavors or elements of risk.

At step 702, ML module 208 receives the enhanced user data records from the data enhancement module 206.

At step 704, the ML module 208 creates datasets for different sub-models. This process may include two steps. Initially, the ML module 208 may create clusters of users based on the enhanced data records. In particular, it may select an arbitrary number of clusters (K) and then use the cosine similarity matrix as input to a K-means algorithm. In one example, the clusters can be determined based on one or more preselected features, e.g., spending behaviors, the bank a user banks with, the computing device used by the user, etc. It will be appreciated that in other embodiments, any other preselected features may be utilized to create the clusters without departing from the scope of the present disclosure.

The ML module 208 then determines the average loan default rates of the users in each of these clusters to identify one or more clusters that have higher than the average loan default rates (e.g., higher than a threshold rate about the average rate) and identify one or more clusters that have lower than the average loan default rates (e.g., lower than a threshold rate below the average rate).

The clusters identified as having lower than average loan default rate may be clustered together into one dataset and the clusters identified as having higher than average loan default rates may be clustered together into another dataset.

The remaining clusters may be combined to form a third dataset.

In the second step, other datasets may be created in a similar manner, but based on criteria other than loan default rates, e.g., based on the source database 130 from which the data was received, or the bank with which a user banks, to provide a few examples. It will be appreciated that the user data records are sampled and added to datasets until all user data records are represented roughly equally and part of at least two datasets. For example if there are four datasets, step 704 ends when all user data records are represented at least in 2-3 of the datasets. This is done to ensure that a particular cohort of people have not been oversampled and that the model is trained on a dataset that is representative of the user base.

Each of the datasets created at step 704 is then further divided into three sets—a training dataset, a validation dataset, and a test dataset at step 706. In one example, the data records in each of the datasets may be sorted based on the date the corresponding user took their first loan. Then the first 70% of the sorted data records may form part of the training dataset, the next 10% of the data records may form part of the validation dataset and the next 10% of the data records may form part of the sub-model test dataset and the last 10% of the records form part of the ensemble model test database.

At step 708 each of the datasets created at step 706 is used to train, validate, and test a corresponding ML sub-model.

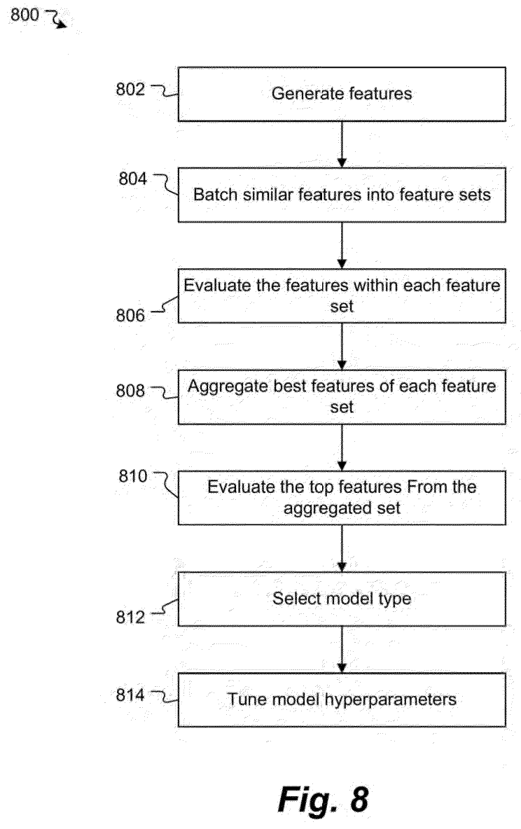

FIG. 8 is a flowchart illustrating an example method 800 for training, validating and testing a sub-model. This method 800 is repeated for each sub-model.

The method 800 commences at step 802, where the ML module 208 generates machine learning features from the dataset associated with that model. A machine learning feature (also referred to as a feature in short) is an individual measurable property or characteristic of the input data that can be used as input for the sub-model. Features are variables or attributes that the model uses to make predictions about risk.

The features can be generated based on the types of variables, their distribution, and the relationship between various features. In some examples, the generated features may be time-based—e.g., hourly, daily, weekly, monthly spending behaviors, saving behaviors and/or income. The features may also be generated using aggregation methods using statistical measures such as average, minimum, maximum, standard deviation, etc. of the various variables in the dataset, such as average spending behaviors, minimum spends, maximum spends, standard deviations from the average, etc. Other features may be generated based on the internal category tags—e.g., spending on retail, groceries, health, pharmaceuticals, etc. In other examples, features may be generated based on types of transactions, e.g., only debit transactions in credit card accounts or only credit transactions in bank accounts. Still further features may be generated based on geodemographic filters—e.g., location of expenditures, etc. It will be appreciated that these are only a few examples and that any other variable filters or combinations of variable filters may be applied to generate features.

It will be appreciated that innumerable features can be generated from the enhanced data records using any attribute or combination of attributes of the dataset as described above. However, the ML module 208 may only select some of the features as candidate features (e.g. 10,000-100,000 features) for that particular model. In one example, the candidate features may be selected based on the number of users a feature relates to. For example, if a feature relates to a threshold number of user (e.g., 20-30% of the users in the dataset), the feature may be selected as a candidate feature. Otherwise, it may be discarded. Further still, in some embodiments, a feature may also be selected if it relates to less than a threshold number of users (e.g., less than 2% of the users in the dataset). These features are selected as they may be predictive of default risk. For example, it may be the case that 0.1 of users spend at a certain shop. However, of those people, 50 of those users may default. So even though that feature occurs very rarely, it would be considered a strong predictor of risk.

In another example, the candidate features may be selected based on the number of times certain behaviors or events occur. For example, if a feature results in a threshold number of event occurrences being selected (e.g., 20-30% of occurrences), the feature may be selected. Otherwise, the feature may be discarded. Further still, in some embodiments, a feature may also be selected if it relates to less than a threshold number of occurrences of events (e.g., if it related to less than 2% of the events in the dataset).

At step 804, ML sub-model 210 batches thematically similar features together into a feature set. This step is performed such that the end sub-model is forced to pick features from different batches having different themes and does not simply pick all the features that are related to only one theme. This increases the diversity of the sub-models and robustness of the model as it is forced to consider a broader range of attributes and/or categories. Batching similar features typically refers to organizing data points that share similar characteristics or have similar values within each batch. This can be relevant in scenarios where grouping similar instances together might provide some benefits during the training or inference phase. To batch the features together, the system may initially define a criteria for similarity based on the characteristics of data. Similarity could be determined by the values of specific features, patterns, or other relevant attributes. For example, the system may batch all the features that relate to spending in a particular location in a feature set. Similarly, it may batch features that relate to a particular bank in a feature set. The batching strategy may involve using clustering algorithms (such as K-means, hierarchical clustering, or DBSCAN) to cluster similar features together or by defining explicit rules based on feature values.

It will be appreciated that the feature sets need not be of the same size, but they will generally be thematically similar in some way. The number of feature sets created at this step may vary depending on the implementation. For example if a sub-model is configured to process about 100K different user records, about 1000 feature sets may be created for about 100,000 features. Alternatively, the sub-model is configured to process more than two million different user records, only 30 feature sets may be created for about 5000 features.

At step 806, the ML module 208 performs a feature evaluation for each feature in each feature set and picks the top one or more features from each feature set. Feature evaluation, also known as feature importance analysis, is the process of assessing the significance of each generated feature in a feature set with respect to the ML model's performance. This analysis helps identify the most influential features in a feature set, understand their impact on the model, and potentially refine the identified features for improved model performance.

Various techniques may be employed for feature evaluation and the choice of the technique may depend on the data type and the ML algorithm used. Generally speaking, in feature evaluation, the entropy of each feature and the predictive capability of the model (based solely on that feature) is determined. Features that have the highest entropy and/or result in the highest correct predictability of the model are selected from each feature set as a candidate feature for the ML model.

In one example, feature evaluation may be performed using elastic net for each feature, using gradient boosted trees algorithm to determine the best features and using Principal Component Analysis to reduce the dimensionality of the data.

Elastic net is a regression algorithm that combination L1 and L2 regularization to prevent overfitting and identify irrelevant or highly correlated features. Once the elastic net algorithm is applied to the features, the coefficients assigned by the algorithm can be examined. These coefficients indicate the strength and direction of the relationship between each feature and the entropy of the feature. Features with non-zero coefficients may be considered important, while features with zero coefficients may be considered unimportant. Further, larger coefficients may suggest stronger impact on the predicted outcome, while smaller coefficients may indicate less relevance.

Gradient Boosted Trees (GBT) is an ensemble learning algorithm that combines the predictive power of multiple decision trees to create a strong predictive model. The algorithm builds trees sequentially, with each tree attempting to correct the errors made by the previous ones. This iterative process allows GBT to capture complex relationships within the data. Based on how often and how much a feature is used across all the trees indicates its importance. Features that contribute more to reducing the loss during the training process are considered more important. Further, each decision tree contributes to the final prediction capability of the model. By analyzing the importance of each feature in individual trees, features that are important in specific parts of the data can be identified.

PCA is a dimensionality reduction technique that transforms the original features of a dataset into a new set of uncorrelated variables called principal components. These principal components capture the most significant information in the data, allowing for a reduction in dimensionality while retaining as much of the variability as possible. Generally speaking, PCA performs an orthogonal transformation to convert correlated features into the set of principal components. These components are ordered by the amount of variance they explain. Features with higher loadings on a principal component are more important for that component. The ML module 208 may use correlation matrices on the reduce dimensionality to remove the most correlated features.

At step 808, the ML module 208 aggregates the best features identified at step 806 above from each feature set. This aggregated features may be determined by an entropy threshold and a number threshold. In one example, the entropy threshold may be 300 and the number threshold may be 5. In this case, the top 5 features from each group may be selected and feature with an entropy value greater than 300 may be selected. In some embodiments, the number of features selected from each feature group may be such that across all groups there are about 1000 features. For example, if there are 200 feature sets, 5 top features may be selected from each group to result in the 1000 total features at step 808.

At step 810, the ML module 208 performs feature evaluation again on the aggregated features to further reduce the feature set. This step is similar to step 806 and is therefore not described here again in detail. In general, the sub-models may be trained using the aggregated features and then a certain number of features may be removed from the aggregated set, which are considered the least useful features (this may be determined based on the entropy of the candidate features). This process is repeated until any further reduction in the features results in a non-trivial change in the accuracy of the model. In one implementation, if 1000 features are present at the start of step 810, the output of step 810 may be approximately 500 features.

At step 812 a ML model is selected for the sub model. Examples of model types that may be selected include, a generalized additive model (GAM), a gradient boosted trees model (GBT), or a neural network. A neural network model may be selected for data with higher dimensionality (e.g., a 3d grid of data where users, features and time may be on different dimensions), whereas the GAM or GBT may be utilized for data with lower dimensionality (e.g. 2d grid of data including users and features in different dimensions).

At step 814, the hyper-parameters of the sub-model are tuned. Hyperparameters are external configurations for a model that cannot be learned from the data and must be set before training. Tuning involves finding the best combination of hyperparameters to improve a model's accuracy and generalization.

The hyperparameters for GAMs are typically smoothing functions and penalties and these can be tuned by using cross validation to assess model performance for different values of smoothing parameters and penalties using the validation dataset.

GBT models have several hyperparameters that control aspects like the number of trees, the learning rate, and the depth of each tree. Each of these hyperparameters can be tuned to improve the model's performance.

Neural networks have various hyperparameters that influence their architecture, training, and regularization. These include, learning rate, batch size, number of epochs, number of hidden layers and neurons, etc. Each of these hyperparameters can be tuned at step 814 to improve the model's performance. The validation dataset may be utilized to tune the hyperparameters.

Once the hyperparameters are tuned, the test dataset may be utilized to test the sub-model. In particular, the default outcomes of the user data records in the test dataset are removed and the user data records are provided sequentially as input to the tuned sub-model. The risk outcomes generated by the sub-model for each user data record is then compared with the actual default outcomes of that corresponding user. If the predicted risk scores are in line with the actual default outcomes at least a threshold number of times (e.g., 90%), the sub-model is considered trained and ready for deployment. Otherwise, the sub-model may be retrained, e.g. by performs the steps of method 800 again.

Returning to FIG. 4, at step 410, the outputs from the sub-models 210 are combined into an ensemble model. The ensemble model may combine the risk scores obtained from the various sub-models in two different ways. As described previously, each user record may be part of the dataset provided to at least two of the sub-model. Accordingly, for every user data record, each sub-model generates a predictive risk score. The first way these risk scores are combined is via a linear weighted summation. That is, the risk score from each sub-model is assigned a weight and the weighted risk scores are then added to obtain a single risk score. The second way these risk scores are combined is via a shallow decision tree. This may be done by finding boundaries (values where the data set is split into separate buckets) which divide the users into a defaulting and non-defaulting group. The linear weight summation may be useful when the risk scores for a particular user data record from different sub-models are relatively similar scores and the shallow decision tree approach is useful in case the risk scores for a particular user data record from different sub-models are dissimilar. The dissimilar risk scores may indicate edge cases or discontinuities in the assessment of risk by the sub-models. If there are less than a threshold percentage of cases where the sub-models generate dissimilar scores for users, the system may determine that these are edge cases and should be reviewed again more closely. On the other hand, if there are more than a threshold percentage of cases where the sub-models generate dissimilar scores for users, the system may determine that one or more of the sub-models are not functioning correctly and may need to be retrained.

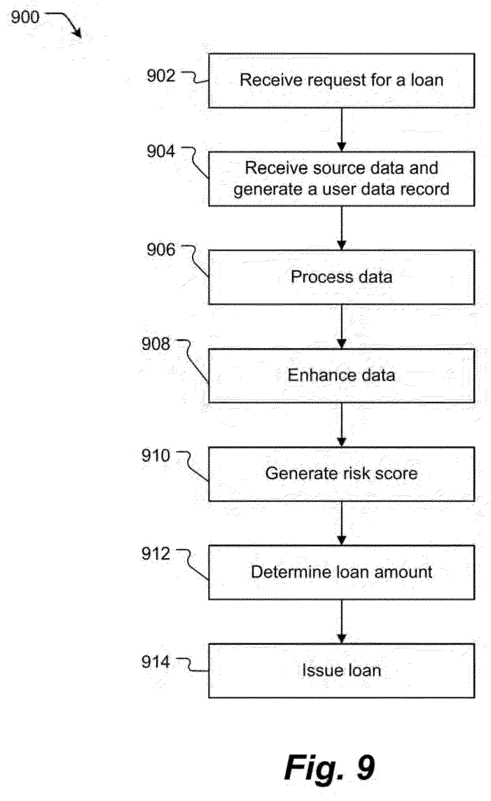

At step 412, the trained risk assessment system is deployed and may be used to predict the risk in providing a service (e.g., a loan) to a requesting user (as will be described in more detail with respect to FIG. 9).

At step 414, live data (that is risk scores and subsequent repayment behavior) is collected by the risk assessment application 114 and feedback to the various modules of the risk assessment platform 112 to improve their accuracy. For example, live data maybe collected for a predetermined period and used to reselect and train the sub-models.

### Requesting a Service

FIG. 9 is a flowchart illustrating an example method 900 of using the trained risk assessment application for determining risk scores. In the present application, it is assumed that the risk assessment application determines a risk score between 0-100% for a user to default on a loan repayment for a loan amount requested by the user.

Method 900 commences at step 902, where the server environment 110 receives a loan request from a client application 122. The loan request includes a requested loan amount and a user identifier.

At step 904, the risk assessment application receives source data associated with the loan request. Some of the source data may be received from the client application 122 of the user that made the request and other source data may be received from one or more of the source databases 130. For example, the user may provide information about the user's bank accounts, network, social media accounts, and other financial accounts. The risk assessment platform 112 may utilize this information to query the corresponding bank database, financial database, social media database, and bureau database to retrieve data records associated with the requesting user for a predetermined time period (e.g., last 3 months, last 6 months, last year, etc.). Further still, the user may upload images (e.g., of bank statements and identifying documents) via their client application 122 and provide geodemographic data (e.g., age, location, gender, etc.) via an input form in the client application 122. In some embodiments, the client application may also obtain behavioral data from the user's client system and provide this to the risk assessment platform. Finally, if the user has previously requested a loan, historical loan data may be retrieved from the data storage 118.

At step 906, the risk assessment application 114 creates a user data record based on all the information received for the user from the source databases 130 and client application 122 and processes the user data record. In one example, the user data record may be processed in the same way the data records are processed in method 500—that is, errors are identified and corrected in the user data record, missing data is imputed, vector embeddings are generated, some of the input data is categorized, and duplicate data is removed.

At step 908, the processed user data record is enhanced. In some examples, the user data record may be enhanced in a manner similar to step 610 of method 600—that is individual behavior trends are determined for the user based on the user data record and these behavior trends are added to the user data record (as vector embeddings).

At step 910, the enhanced user record is provided to the ML module 208. In some embodiments, the ML module 208 may provide the user record to two or more sub-models. The sub-models are chosen based on the user data records. For example, if a user has a device type of iPhone, then a sub-model which is based on iPhones may be chosen. Similarly, if a user banks with a certain bank, the user records are provided to the sub-model associated with that bank. In case the ML module 208 includes four sub-models including a sub-model for first time borrowers, a sub-model for repeat borrowers, a baseline sub-model and a seasonal sub-model, and the user is a repeat borrower, the enhanced user record may be provided to the baseline sub-model and the repeat borrower sub-model.

Each of the sub-models the user record is provided to generates a risk score indicating the probability that the user would default on a loan provided to the user.

The output from each of the risk sub-models is then combined in an ensemble model to generate a single risk score value. The single risk score value may indicate the risk of default.

At step 912, a service application may receive the requested loan amount and the risk score computed by the risk assessment application 114 and determine a loan amount to be provided to the user. This determination may be based on the request loan amount and the risk score. The lower the risk score, the closer to the requested amount the determined loan amount may be and the higher the risk score, the further from the requested amount the determined loan amount may be.

In the methods 4-9 described above, where client application 122 operates to display controls, interfaces, or other objects, client application 122 does so via one or more displays that are connected to (or integral with) system 300—e.g. display 318. Where client application 122 operates to receive or detect user input, such input is provided via one or more input devices that are connected to (or integral with) system 300—e.g. a touch screen, a touch screen display 318, a cursor control device 324, a keyboard 326, and/or an alternative input device.

In the above embodiments certain operations are described as being performed by the client system 120 (e.g. under control of the client application 122) and other operations are described as being performed at the server environment 110. Variations are, however, possible. For example in certain cases an operation described as being performed by client system 120 may be performed at the server environment 110 and, similarly, an operation described as being performed at the server environment 110 may be performed by the client system 120. Generally speaking, however, where user input is required such user input is initially received at client system 120 (by an input device thereof). Data representing that user input may be processed by one or more applications running on client system 120 or may be communicated to server environment 110 for one or more applications running on the risk assessment platform 112 to process. Similarly, data or information that is to be output by a client system 120 (e.g. via display, speaker, or other output device) will ultimately involve that client system 120. The data/information that is output may, however, be generated (or based on data generated) by client application 122 and/or the server environment 110 (and communicated to the client system 120 to be output).

The flowcharts illustrated in the figures and described above define operations in particular orders to explain various features. In some cases the operations described and illustrated may be able to be performed in a different order to that shown/described, one or more operations may be combined into a single operation, a single operation may be divided into multiple separate operations, and/or the function(s) achieved by one or more of the described/illustrated operations may be achieved by one or more alternative operations. Still further, the functionality/processing of a given flowchart operation could potentially be performed by (or in conjunction with) different applications running on the same or different computer processing systems.

Unless otherwise stated, the terms “include” and “comprise” (and variations thereof such as “including”, “includes”, “comprising”, “comprises”, “comprised” and the like) are used inclusively and do not exclude further features, components, integers, steps, or elements.

Although the present disclosure uses terms “first,” “second,” etc. to describe various elements, these terms are used only to distinguish elements from one another and not in an ordinal sense. For example, a first source database or first source data could be termed a second source database or second source data or vice versa without departing from the scope of the described examples. Furthermore, when used to differentiate elements or features, a second source database could exist without a first source database. For example, a second user input could occur before a first user input (or without a first user input ever occurring).

It will be understood that the embodiments disclosed and defined in this specification extend to alternative combinations of two or more of the individual features mentioned in or evident from the text or drawings. All of these different combinations constitute alternative embodiments of the present disclosure.

The present specification describes various embodiments with reference to numerous specific details that may vary from implementation to implementation. No limitation, element, property, feature, advantage, or attribute that is not expressly recited in a claim should be considered as a required or essential feature. Accordingly, the specification and drawings are to be regarded in an illustrative rather than a restrictive sense.

1. A method for training a machine learning model to assess risk, the machine learning model comprising a plurality of machine learning sub-models and an ensemble model, the method comprising:
receiving a plurality of user data records, each user data record comprising data collected for an individual user from multiple data sources;
creating the plurality of machine learning sub-models based on the plurality of user data records;
assigning at least a subset of the plurality of user data records to each of the plurality of machine learning sub-models;
training each machine learning sub-model using the assigned subset of the plurality of user data records, each sub-model trained to accurately determine a risk score based on a given user data record;
providing the risk scores generated by each of the plurality of machine learning sub-models to an ensemble machine learning model, the ensemble machine learning model being trained to combine the risk scores from the sub-models to obtain a combined risk score;
using the trained machine learning model to determine a risk score for an individual user data record; and
reusing the determined risk score for the individual user record to retrain the machine learning model.

2. The method of claim 1, further comprising generating enhanced user data and adding the enhanced user data to each user record of the plurality of user records to generate enhanced user records, the enhanced user data comprising one or more of:
seasonal and/or macro trends for the user, and/or
seasonal, and/or macro trends for one or more subsets of users.

3. The method of claim 2, wherein generating the enhanced user data comprises:
identifying clusters of similar user data records in the plurality of user data records;
determining seasonal trends for each of the identified clusters;
determining macro trends for each of the identified clusters; and
determining individual behaviors of users in each cluster by comparing individual user data records in each cluster with the seasonal trends and/or macro trends determined for that cluster.

4. The method of claim 3, wherein creating the plurality of machine learning sub-models comprises:
receiving the enhanced user data records; and
creating clusters of users based on the enhanced user data records, the clusters determined based on one or more preselected features from the user data records;
identifying one or more clusters that have a higher default rate than a high threshold default rate and identifying one or more clusters that have a lower default rate than a low threshold default rate; and
creating a first sub-model based on the one or more clusters having a higher default rate than the high threshold default rate, creating a second sub-model based on the one or more clusters that have a lower default rate than the low threshold default rate, and creating a third sub-model based on the remaining clusters.

5. The method of claim 3, wherein creating the plurality of machine learning sub-models comprises:
receiving the enhanced user data records;
creating clusters of users based on the enhanced user data records, the clusters determined based on one or more preselected features from the user data records;
identifying one or more clusters that are associated with a criteria including a type of banking institution or a data source of the user data; and
creating a sub-model for each of the identified one or more clusters.

6. The method of claim 1, wherein training each machine learning sub-model using the assigned subset of the plurality of user records comprises:
for each sub-model:
generating a plurality of machine learning features from the assigned subset of the plurality of user records based on attributes or combination of attributes of the user data records;
selecting a subset of the plurality of machine learning features as training features;
selecting a machine learning model for the sub-model based on a dimensionality of the data in the user data record; and
tuning hyperparameters of the sub-model using the assigned subset of user data records.

7. The method of claim 6, wherein selecting the training features comprises:
selecting a subset of the plurality of machine learning features as candidate features;
clustering the candidate features into a plurality of clusters based on a predetermined similarity criteria;
assessing entropy of each candidate feature and a predictive capability of the sub-model based on each candidate feature independently;
aggregating a subset of the candidate features from each cluster into an aggregated feature set, the subset of candidate features being selected at least in part based on the entropy of the candidate features being above a threshold value; and
selecting a subset of the aggregated features as the training features.

8. The method of claim 7, wherein the candidate features are selected based on a number of users the machine learning feature relates to, where machine learning features that relate to greater than a first threshold number of users are selected as candidate features and machine learning features that relate to less than a second threshold number of users are selected as candidate features.

9. The method of claim 7, wherein the candidate features are selected based on a number of times one or more behaviors or events occur, where machine learning features that relate to greater than a first threshold number of behaviors or events are selected as candidate features and machine learning features that relate to less than a second threshold number of behaviors or event are selected as candidate features.

10. The method of claim 1, wherein combine the risk scores from the sub-models to obtain a combined risk score comprises: performing a linear weighted summation on the risk scores generated by the plurality of machine learning sub-models, or using a shallow decision tree.

11. The method of claim 1, wherein each user record in the plurality of user data records is assigned to at least two sub-models.

12. The method of claim 1, further comprising generating vector embeddings for non-numerical data in the user data records, the vector embedding being generated by a vector embedder than is custom trained to generate vector embeddings from non-natural language data.

13. The method of claim 1, further comprising: categorizing data in the user data records using normalized classification.

14. The method of claim 1, wherein each user data record includes one or more of network data, bureau data, social media data, financial data, image data, historical data and behavioral data collected over a period of time.

15. The method of claim 1, further comprising classifying data in the user data records as time series data or static data.

16. The method of claim 1, wherein using the trained machine learning model to determine the risk score for the individual user data record comprises:
cleaning the user data record;
enhancing the user data record to include behavior trend of the user that is determined based on the user data record;
providing the enhanced user data record to at least two sub-models of the plurality of machine learning sub-models;
receiving a risk score from each of the at least two sub-models;
providing the risk score from each of the at least two sub-models to the ensemble model to obtain a combined risk score.

17. The method of claim 16, further comprising:
receiving a request for a loan from the user associated with the individual user data record;
determining a loan amount to be provided to the user based on the combined risk score.

18. The method of claim 17, wherein the request includes a requested loan amount and the determined loan amount is based on the requested loan amount.

19. A computer processing system including:
one or more processing units; and
one or more non-transitory computer-readable storage media storing instructions, which when executed by the one or more processing units, cause the one or more processing units to perform a method according to any one of claims 1 to 18.

20. One or more non-transitory storage media storing instructions executable by one or more processing units to cause the one or more processing units to perform a method according to any one of claims 1 to 18.
